(19) United States
(12) Patent Application Publication
(10) Pub. No.: US 2009/0224685 A1
(43) Pub. Date: Sep. 10, 2009

(54) DRIVE CIRCUIT FOR DRIVING A GAS DISCHARGE LAMP, AND METHOD OF CALIBRATING A DRIVE CIRCUIT

(75) Inventors: Lambertus Henricus Cornelis De Brouwer, Eindhoven (NL); Patrick John Zijlstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,588

(22) PCT Filed: Sep. 19, 2005
(86) PCT No.: PCT/IB05/53063

§ 371 Date: Mar. 20, 2007

(30) Foreign Application Priority Data
Sep. 27, 2004 (EP) 04104679.8

(51) Int. Cl. H05B 37/02

(52) U.S. Cl. 315/291

(57) ABSTRACT

A method is described for calibrating a CDCCD circuit (100) comprising: first and second voltage input terminals (101, 102); first and second switching bridges, each comprising two controllable switches connected in series between said first and second input terminals; a series arrangement of a first inductor (131), load output terminals (191, 192), and a second inductor (132) coupled between bridge output nodes (113, 123); a current sensor (150) associated with said first inductor (131); a reference signal generator (160); a switch controller (170) receiving a measuring signal (S 1) from the current sensor and a reference signal (SR) from the reference signal generator; the method comprising the steps of: generating an AC current having a zero DC level; measuring a voltage at an output terminal; adjusting the current reference signal in such a way that the measured voltage is symmetrical with respect to the input voltage levels.

### FIELD OF THE INVENTION

The invention relates in general to an electronic DC/AC drive circuit for driving an operational current in a load. The invention particularly relates to such a circuit for operating a lamp, specifically a gas discharge lamp, more specifically a high-pressure gas discharge lamp. The invention will hereinafter be explained in more detail with reference to a high-pressure gas discharge lamp, but this is by way of example only and should not be interpreted as limiting the scope of the invention.

### BACKGROUND OF THE INVENTION

High-pressure gas discharge lamps should ideally be operated with an alternating current, so that, on a time scale larger than the period of the alternating current, the average DC level of the current is zero. Electronic circuits have been developed, which are capable of generating suitable lamp currents, in accordance with different designs. One category of such electronic circuits is designed to generate a commutating current, derived from a constant input voltage.

The invention specifically relates to an electronic lamp drive circuit of the type which comprises two independently controlled half-bridges, one half-bridge operating as a down-converter, and the other half-bridge operating as a commutator. Such a type of electronic lamp drive circuit will hereinafter be indicated as Combined Down-Converter Commutator Drive circuit, CDCCD circuit for short.

Examples of a CDCCD circuit are disclosed in WO-03/056886. Each half-bridge comprises two switches connected in series; the node between these switches constitutes an output of the corresponding bridge. A series arrangement of a first inductor, a lamp and a second inductor is connected between the two bridge output nodes. A controller controls the switches on the basis of a signal received from a current sensor, which senses the current through the first inductor. The controller also receives a reference signal. As a result of the switching action of the switches, the lamp current drops and rises at a relatively high frequency, so that the average lamp current follows the waveform of the reference signal. The reference signal, in turn, is generated in such a way that the average level of the lamp current is zero.

For a more elaborate explanation of the operation of the circuit, reference is made to WO-03/056886, the contents of which are herein incorporated by reference.

An important aspect of a correctly functioning CDCCD circuit is the accuracy of the current sensor, especially around the zero average lamp current. In practice, it may happen that a current sensor shows a small offset, which means that the output signal is not exactly zero when the measured current is actually equal to zero. Furthermore, current sensors are not exactly equal to each other, i.e. different current sensors may have different offsets. The controller has such a control action that the average measuring signal is zero. However, if the measuring signal is not proportional to the lamp current, especially if the measuring signal is offset with respect to the measured current, then the actual average current is not equal to zero. This situation would be very disadvantageous for the lamp driver as well as for the lamp, as it may increase power losses and shorten the maximum life of the driver and/or the lamp.

A further important aspect is that the sensor offset may change for any reason during operation, for instance, by thermal, mechanical, or magnetical influences, etc. Especially in the first minutes after lamp ignition, the largest thermal changes are expected.

A general objective of the invention is to improve the known CDCCD circuit and the accuracy of the current sensor.

### SUMMARY OF THE INVENTION

In accordance with a first aspect of the invention, the controller is capable of operating in a calibration mode before the ignition mode. In the calibration mode, the zero level of the current sensor is detected. During the normal operational mode, the controller takes into account the offset characteristics of the sensor as determined during the calibration mode.

In a specific embodiment, the current reference signal for the controller is generated by a controllable reference signal generator, whose setting is controllable by the controller. The CDCCD circuit further comprises a voltage sensor, measuring the lamp voltage. In the calibration mode, the controller drives the switches in such a way that an alternating lamp voltage is generated, while ensuring that no lamp current flows. The controller adjusts the setting of the reference signal generator in such a way that the average output voltage is equal to half the value of the input voltage. During the normal operational mode, the reference signal generator operates with the adjusted setting.

In a preferred embodiment, the controller keeps the switches of the commutating half-bridge in their OFF state during the calibration mode in order to ensure that no current can flow through the lamp.

In accordance with a second aspect of the invention, the controller is capable of operating in a recalibration mode during the normal operational mode. In the recalibration mode, the normal operation is briefly interrupted, so that the lamp current is zero, and a calibration measurement is performed, after which normal operation is resumed. The interruption is much shorter than half the current period, so that the lamp immediately ignites when normal operation is resumed, and the brief interruption of the light is hardly noticeable to the human eye. The recalibration mode is performed during positive current periods as well as during negative periods, and the results are combined to calculate an adjusted setting for the reference signal generator.

### BRIEF DESCRIPTION OF THE DRAWINGS

These and other aspects, features and advantages of the invention will be further explained by means of the following description with reference to the drawings, in which identical reference numerals indicate identical or similar parts, and in which:

FIG. 1 is a block diagram showing a CDCCD circuit according to the invention;

FIG. 2 is a graph showing the lamp current as a function of time;

FIG. 3 is a graph showing the lamp current as a function of time on a larger time scale;

FIG. 4A is a graph illustrating an offset of a current sensor;

FIG. 4B is a graph illustrating a consequence of a current sensor offset;

FIG. 5 is a graph illustrating an effect of a shifted reference signal;

FIGS. 6A-B are block diagrams illustrating alternative embodiments of a CDCCD circuit according to the invention;

FIG. 7 is a graph illustrating the AC lamp current and the current-measuring signal during a calibration mode according to the invention;

FIG. 8 is a graph showing a voltage-measuring signal as a function of time;

FIG. 9 is a graph showing the current during a recalibration sequence.

### DETAILED DESCRIPTION OF THE INVENTION

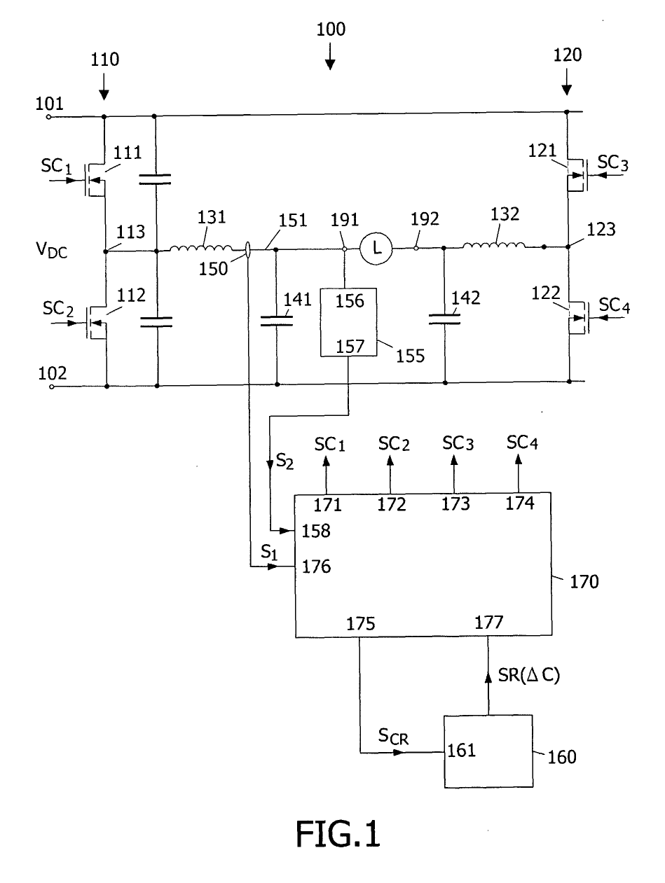

FIG. 1 is a block diagram showing a CDCCD circuit 100 according to the invention. The CDCCD circuit 100 has a first input terminal 101 and a second input terminal 102 for connection to an input voltage source (not shown), which is expected to provide a DC voltage VDC wherein the first terminal 101 is positive with respect to the second terminal 102.

The CDCCD circuit 100 comprises a first switching bridge 110 and a second switching bridge 120, connected in parallel between said first and second input terminals 101, 102. The first bridge 110 comprises a series arrangement of a first controllable switch 111 and a second controllable switch 112, the node 113 between these two switches 111, 112 constituting a bridge output node. Likewise, the second bridge 120 comprises a series arrangement of a third controllable switch 121 and a fourth controllable switch 122, the node 123 between these two switches constituting an output node of the second bridge. As illustrated, the controllable switches are suitably implemented as MOSFETS.

The CDCCD circuit 100 has a first load output terminal 191 and a second load output terminal 192 for connecting a load L. In the illustration of FIG. 1, a lamp L is connected between these two output terminals 191, 192. In the following description, the operation of the CDCCD circuit 100 will be further explained with reference to a lamp as a load, but it should be recognized that the CDCCD circuit 100 can be used for driving other types of loads.

The CDCCD circuit 100 further comprises a first inductor 131, for instance, a coil, connected between the first bridge output node 113 and the first load output terminal 191, and a second inductor 132, for instance, a coil, connected between the second bridge output node 123 and the second load output terminal 192. Furthermore, the CDCCD circuit 100 comprises a first capacitor 141 connected between the first load output terminal 191 and the second input terminal 102, and a second capacitor 142 connected between the second load output terminal 192 and the second input terminal 102. Alternatively, one or both of the first and second capacitors 141, 142 may be connected to the first input terminal 101, or to any other source of constant potential.

The CDCCD circuit 100 further comprises a current sensor 150 arranged to measure the current in the first inductor 131, and designed to generate a current-measuring signal S1 representing the measured current. In the embodiment as illustrated, the current sensor 150 is shown at a position associated with a current-conducting line 151 connecting the first inductor 131 with the first load output terminal 191, thus actually measuring the current between the inductor 131 and the output terminal 191. However, it should be noted that this current is identical to the current in the inductor 131. Furthermore, it should be noted that alternative locations of the current sensor 150 are also possible.

The measuring signal S1 is received at a sensor input 176 of a switch controller 170, which also has a reference input 177 receiving a current reference signal SR generated by a current reference signal generator 160. The switch controller 170 has four control outputs 171, 172, 173, 174, coupled to control inputs of the controllable switches 111, 112, 121, 122, respectively. The switch controller 170 is designed to generate control signals SC1, SC2, SC3, SC4 for the four controllable switches 111, 112, 121, 122, respectively, in order to control the operative state of these four switches on the basis of the current reference signal SR and the current-measuring signal S1, as will be explained in more detail below.

Each controllable switch has two operative states: a first operative state in which the switch is conductive, and a second operative state in which the switch is non-conductive. In the following description, the conductive state of a switch will also be indicated as ON or CLOSED, whereas the non-conductive state of a switch will be indicated as OFF or OPEN.

Furthermore, a control signal resulting in a switch being open or closed, respectively, will also be indicated as an OPEN signal or a CLOSED signal, respectively.

In normal operation, as will be explained in more detail, the switches of a bridge are controlled to have mutually opposite operative states. This wording is used to indicate that one switch is OPEN, whereas the other is CLOSED, and vice versa. It follows that the bridge as a whole has a first bridge-operative state wherein the switch connecting the output node to the high voltage input terminal 101 is ON, whereas the other switch is OFF, and a second bridge-operative state wherein the switch connecting the output node to the low voltage input terminal 102 is ON, whereas the other switch is OFF. These two bridge-operative states will be indicated as the HIGH state and the LOW state, respectively.

The switching bridges 110, 120 actually also have a third operative state wherein both switches are ON, and a fourth operative state wherein both switches are OFF. A person skilled in the art will recognize that the third operative state, which will be indicated as the SHORT state, is to be avoided because it constitutes a short circuit between the high voltage input terminal 101 and the low voltage input terminal 102. Therefore, the switch controller 170 is designed to generate its control signals for the two switches of one bridge, so that, at a transition from a HIGH bridge state to a LOW bridge state or vice versa, the ON switch is first opened while the OFF switch is closed with a brief delay, so that the transition takes place via the fourth operative state, which will be indicated as the OFF state.

As explained more elaborately in WO-03/056886, the switch controller 170 is capable of operating in three different modes for operating a high-pressure gas discharge lamp, i.e. an ignition mode, a run-up mode, and a normal operational mode. For an explanation of these modes, reference is made to said publication. As far as is relevant for the invention, the operation of the switch controller 170 is explained in more detail with reference to the normal operational mode.

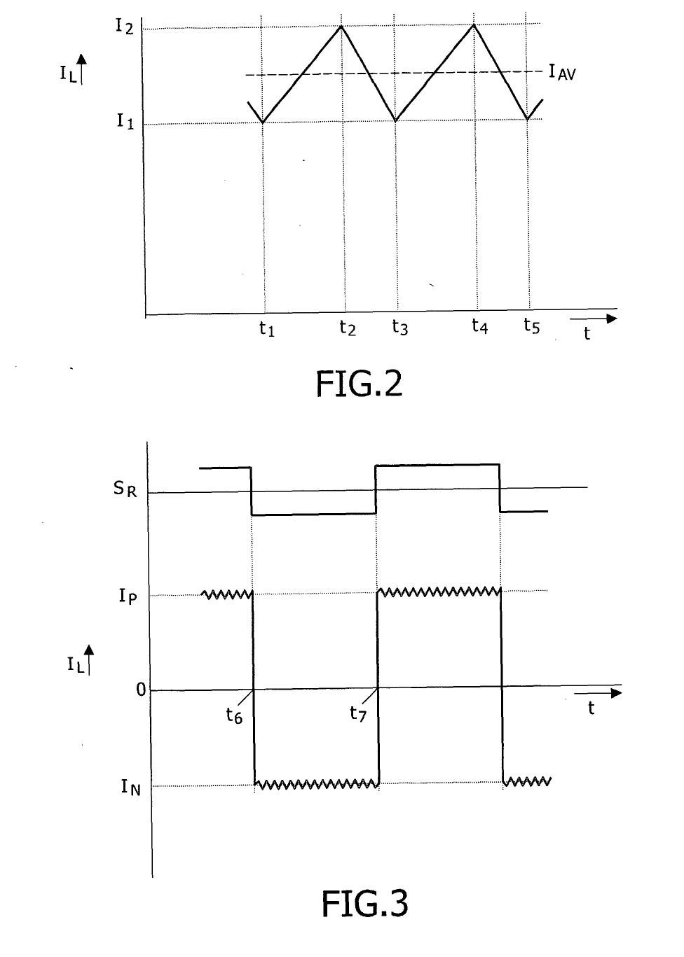

FIG. 2 is a graph showing the lamp current (vertical axis) as a function of time (horizontal axis). The fourth switch 122 is assumed to be in the ON state.

In the normal operational mode, the first bridge 110 is switched from its HIGH bridge state to its LOW bridge state at a relatively high frequency, typically of the order of about 300 kHz.

The lamp current through the lamp L flows in the direction from the first bridge 110 to the second bridge 120. At instant t1, the first bridge 110 is switched to its HIGH state, and the lamp current increases from a low value I1 to a higher value I2 at instant t2, when the first bridge 110 is switched back to its LOW state. From instants t2 to t3, the lamp current decreases from the high value I2 to the low value I1. The above process is repeated as from instant t3. On a time scale larger than (t3-t1), the lamp current has an average value Iav, indicated in FIG. 2 as a horizontal line. The level of this average lamp current Iav is controlled by the switch controller 170 by suitably setting the duty cycle of the first bridge 110, i.e. the ratio of (t2-t1) to (t3-t1).

The above process continues until the second bridge 120 is switched from its LOW state to its HIGH state. Again, the lamp current increases and decreases at a frequency determined by the switching frequency of the first bridge 110, which is also indicated as the down-converter bridge, but now the direction of the lamp current is reversed, so that the lamp current flows from the second bridge 120 to the first bridge 110. FIG. 3 is a graph comparable to FIG. 2, but now on a larger time scale, showing how the average lamp current Iav (vertical axis) changes direction at a frequency determined by the switching frequency of the second bridge 120, also indicated as commutator bridge. More specifically, FIG. 3 illustrates that, before instant t6, when the commutator bridge 120 is in its LOW state (the situation in FIG. 2), the average lamp current Iav has a first direction, arbitrarily indicated as positive direction, and a first magnitude indicated as I_{P}, while after instant t6, when the commutator bridge 120 is in its HIGH state, the average lamp current has the opposite direction, indicated as negative direction, and a second magnitude indicated as I_{N}. This situation continues until instant t7, when the commutator bridge 120 switches back to its LOW state and the average lamp current Iav switches back to the positive direction and magnitude I_{P}. This process is repeated with a commutating frequency determined by the switching frequency of the commutator bridge 120, which typically is of the order of about 100 Hz.

The switch controller 170 generates its control signals SC1, SC2, SC3, SC4 for the four switches 111, 112, 121, 122 on the basis of its input signals received at its inputs 176 and 177. The current reference signal generator 160 generates the current reference signal S_{R}, so that it represents the desired waveform of the lamp current. Typically, this desired waveform is a square wave with a 50% duty cycle and a zero DC level. The control signals for the switches are generated in such a way that the current-measuring signal S1 provided by the current sensor 150 follows this current reference signal S_{R}. In FIG. 3, the current reference signal S_{R} is also shown. It can be seen in FIG. 3 that the current reference signal S_{R} is a customarily symmetrical signal having a 50% duty cycle and a zero DC level, corresponding to the desired waveform of the lamp current.

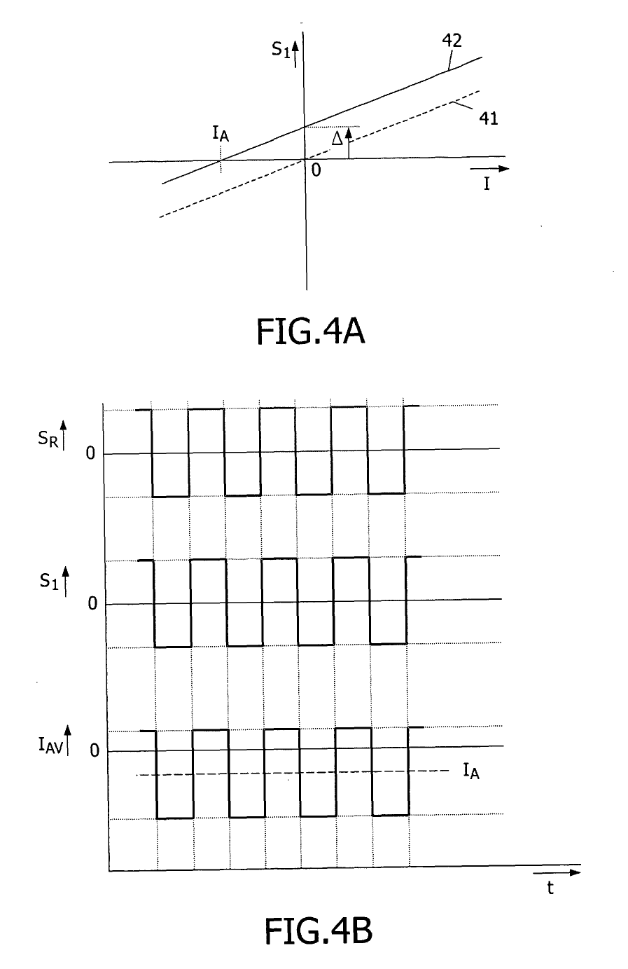

Ideally, the current sensor 150 has a linear characteristic, indicated by the dotted line 41 in FIG. 4A, which shows a graph of sensor output signal S1 (vertical axis) versus actual measured current I (horizontal axis). However, in practice, it may happen that the current sensor 150 shows an offset Δ, such that its characteristic is represented by line 42 in FIG. 4A: if the current is equal to zero, the sensor output signal S1 has a value Δ, and the sensor output signal S1 is equal to zero only when the actual current has a magnitude I_{A}. This constitutes a problem, as is illustrated in FIG. 4B. If the current reference signal S_{R} was a symmetrical signal having a 50% duty cycle and a zero DC level, and if the switch controller 170 was operated in such a way that the sensor output signal S1 is made to follow the reference signal S_{R}, the lamp current would have a DC level equal to I_{A}, i.e. unequal to zero. It is to be noted that, in this case, the sensor output signal S1 would have a value A, so the switch controller 170 would believe that the operation is OK, but the sensor output signal does not accurately represent the actual current, which suffers from a DC offset.

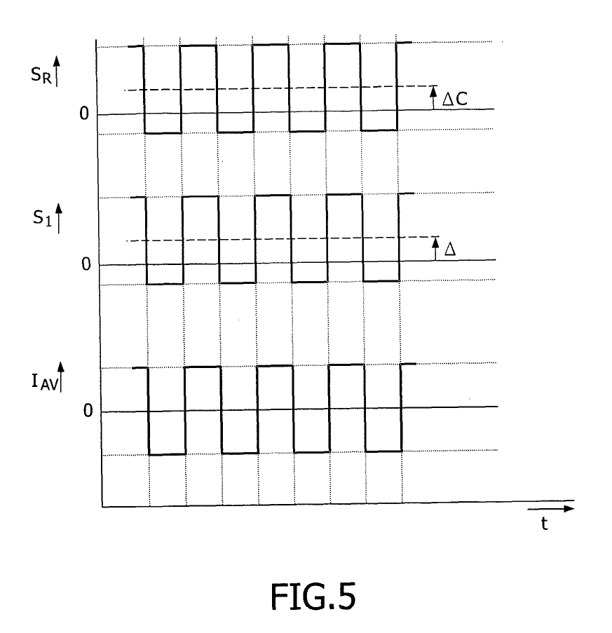

According to the invention, the control action of the switch controller 170 is manipulated in such a way that the actual current has the desired waveform of a 50% duty cycle and a zero DC level while the sensor output signal S1 does not have this desired waveform. In accordance with a first aspect of the invention, the reference signal S_{R} is shifted over a distance Δ_{C}, to obtain a shifted reference signal S_{R}′=S_{R}+Δ_{C} as illustrated in FIG. 5, and the operation of the switch controller 170 is such that the sensor output signal S1 is made to follow the shifted reference signal S_{R}′. In such a case, of course, the sensor output signal S1 now has a DC level Δ which is offset with respect to zero, corresponding to the offset Δ_{C} of the reference signal S_{R}. However, the average lamp current Iav now has a DC level which is substantially equal to zero.

In the embodiment illustrated in FIG. 1, the current reference signal generator 160 is a controllable signal generator having a control input 161 coupled to a fifth control output 175 of the switch controller 170, and the switch controller 170 is designed to generate a reference control signal SC_{R} for the signal generator 160 at its fifth output 175. The signal generator 160 is adapted to generate its reference signal S_{R} with an offset Δ_{C} as determined by the reference control signal SC_{R} received at its control input 161.

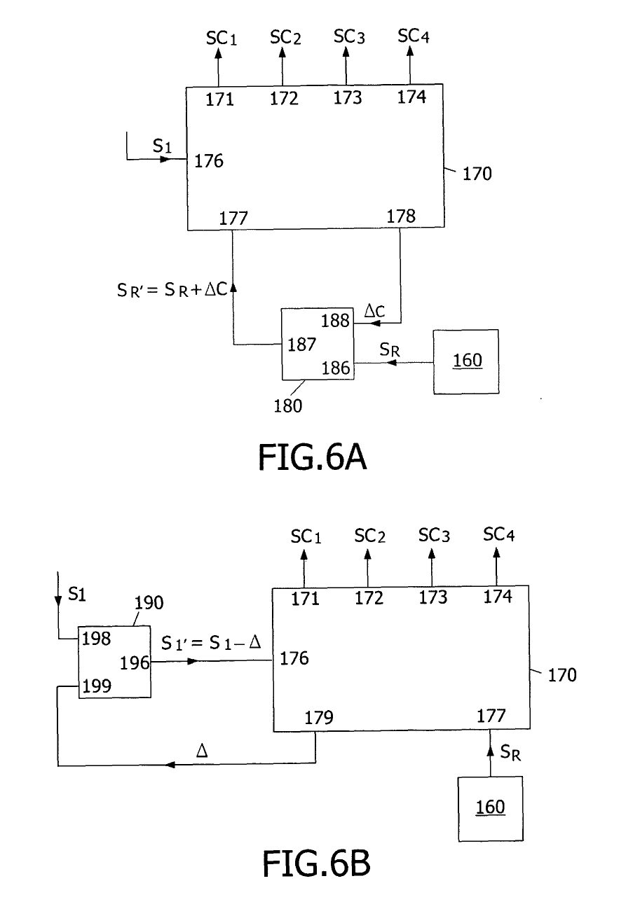

FIG. 6A is a block diagram which is comparable to FIG. 1 and illustrates an alternative embodiment, in which the signal generator 160 does not need to be a controllable generator: in this case, the signal generator 160 is designed to generate a symmetrical current reference signal S_{R} as usual. For the sake of simplicity, only the switch controller 170 and the signal generator 160 are shown in FIG. 6A. The switch controller 170 is provided with an adder 180 having a first input 186 receiving the current reference signal S_{R} from the signal generator 160. The switch controller 170 has an offset output 178 providing an offset signal Δ_{C}, which is received by the adder 180 at a second input 188. The adder 180 adds the two signals received at its two inputs 186 and 188, and generates at an output 187 a corrected current reference signal S_{R}′ which is equal to the summation of the original reference signal S_{R} from the reference signal generator 160 and the offset signal Δ_{C} provided by the switch controller 170, which output 187 is coupled to the reference input 177 of the switch controller 170.

In a modification, the adder 180 is an integral part of the switch controller 170.

In another approach of the invention, the sensor output signal S1 is shifted over a distance Δ in order to compensate the offset in this signal. An embodiment implementing this approach is illustrated in FIG. 6B. The switch controller 170 is provided with a subtractor 190 having a first input 198 receiving the sensor output signal S1_{R} from the sensor 150. The switch controller 170 has an offset output 179 providing an offset signal A, which is received by the subtractor 190 at a second input 199. The subtractor 190 is designed to subtract the signal received at its second input 199 from the signal received at its first input 198, and generates at an output 196 a corrected current sensor signal S₁′=S₁−Δ which is equal to the difference between the original sensor output signal S₁ from the current sensor 150 and the offset signal Δ provided by the switch controller 170, which output 196 is coupled to the sensor input 176 of the switch controller 170.

In a modification, the subtractor 190 is an integral part of the switch controller 170.

In order to be able to determine a suitable value for the control signal S_{CR} (embodiment of FIG. 1), or for the reference signal offset Δ_{C} (embodiment of FIG. 6A), or for the sensor correction signal Δ (embodiment of FIG. 6B), the switch controller 170 is capable of operating in a calibration mode, as will be explained in the following description. In the calibration mode, the switch controller 170 is set to generate a symmetrical lamp voltage in the absence of a lamp current. As a result, if the same setting is used to generate a lamp current, the average lamp current will be zero.

The switch controller 170 executes the calibration mode before the ignition mode, so the lamp L has not ignited yet, and no current can flow through the lamp L. However, in practice, it may happen that some spurious current flows erratically through the lamp L. Furthermore, as mentioned above, the invention is also applicable to cases where the load L is not a discharge lamp, so in general it may happen that the load L is conductive even before the ignition mode. Therefore, in order to prevent any current from flowing through the load L, the switch controller 170 is preferably designed to switch the commutator bridge 120 to its OFF state during the calibration mode.

Thus, it is ensured that no current can flow through the first inductor 131, because such a current would have to flow either through the load L (which is inhibited as explained above) or through the first capacitor 141 (which is inhibited by the characteristics of the first capacitor 141).

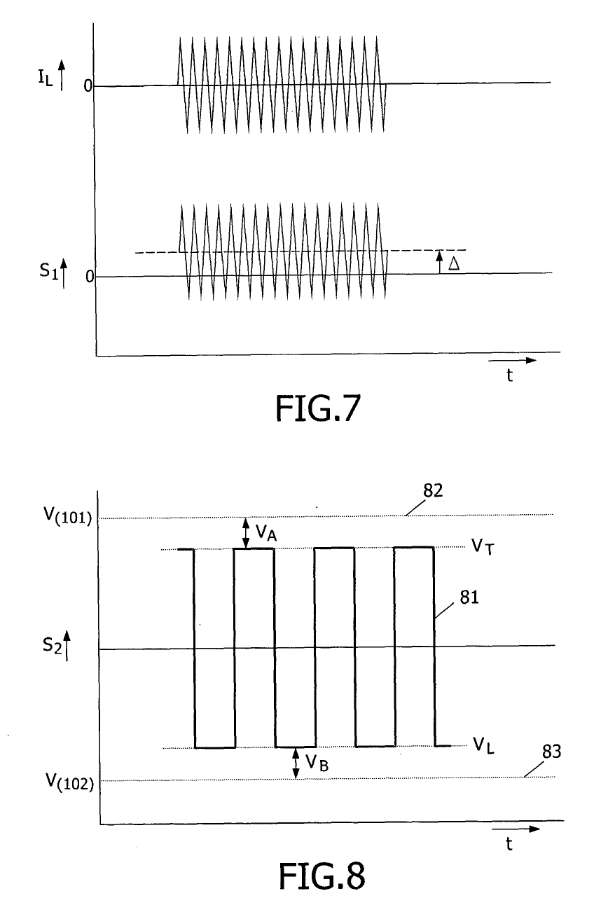

In the calibration mode, the switch controller 170 switches the down-converter bridge 110 from its HIGH state to its LOW state at a relatively high frequency, typically equal to the operation frequency of the down-converter bridge 110 during the normal operational mode. As a result, an AC current I_{L} is generated in the current path from the first bridge output 113 via the first inductor 131 and the first capacitor 141, which is an AC current without any DC component. Thus, as illustrated in FIG. 7, the sensor output signal S1 should now be representative of an AC current without a DC component: any DC component of the current sensor output signal S1 is due to an offset of the current sensor 150, i.e. is equal to the offset Δ in FIG. 4A. Thus, the switch controller 170 is capable of actually measuring the current sensor offset Δ.

For compensating the current sensor 150, the invention uses the voltage at the first output terminal 191. To this end, as illustrated in FIG. 1, the CDCCD circuit 100 comprises a voltage sensor 155 having a sense input 156 connected to the first output terminal 191, and a signal output 157 coupled to a signal input 158 of the switch controller 170. By way of example, the voltage sensor 155 may be implemented as a resistance divider.

FIG. 8 is a graph showing the voltage-measuring signal S2 as a function of time (curve 81). FIG. 8 also shows the voltage level V₁₀₁ at the first input terminal 101 (horizontal line 82), and the voltage level V₁₀₂ at the second input terminal 102 (horizontal line 83). These voltage levels V₁₀₁ and V₁₀₂ are also received by the switch controller 170, but this is not shown in the drawings.

The voltage-measuring signal S2 is shown as a square-wave signal 81 having a top level V_{T} which is lower than the first input voltage level V₁₀₁, and a minimum value V_{L} which is higher than the second input voltage level V₁₀₂. This is, however, not essential.

During a HIGH state of the down-converter bridge 110, the switch controller 170 measures the difference between the voltage-measuring signal S2 and the first input voltage level V₁₀₁. The absolute value of the result of this measurement is indicated in FIG. 8 as voltage difference V_{A}.

During the subsequent LOW state of the down-converter bridge 110, the switch controller 170 measures the difference between the voltage-measuring signal S2 and the second input voltage level V₁₀₂. The absolute value of the result of this measurement is indicated in FIG. 8 as V_{B}. Ideally, the lamp voltage at the first output terminal 191 should be symmetrical with respect to the input voltage levels V₁₀₁ and V₁₀₂. This means that V_{A} should be equal to V_{B}. If V_{A} is not equal to V_{B}, a correction is required so as to reduce the difference V_{A}−V_{B}.

In the embodiment of FIG. 1, the switch controller 170 generates its reference control signal SC_{R} for the current reference signal generator 160 in such a way that the reference signal outputted by the current reference signal generator 160 is shifted (S_{R}(ΔC); see FIG. 5, top graph), shifting the voltage at the first output terminal 191 so as to reduce the difference V_{A}−V_{B}.

The above steps are then repeated until said difference V_{A}−V_{B} is equal to zero within a certain predefined range of tolerances.

The value of the reference control signal SC_{R} thus obtained is maintained by the switch controller 170 in the subsequent ignition, run-up, and normal operational modes.

In the embodiment of FIG. 6A, the switch controller 170 generates its offset signal Δ_{C} for the adder 180 in such a way that the corrected reference signal S_{R}′ outputted by the adder 180 is shifted with respect to the original reference signal S_{R} from the reference signal generator 160 (S_{R}′=S_{R}+ΔC); see FIG. 5 (top graph), shifting the voltage at the first output terminal 191 so as to reduce the difference V_{A}−V_{B}.

The above steps are then repeated until said difference V_{A}−V_{B} is equal to zero within a certain predefined range of tolerances.

The value of the offset signal Δ_{C} thus obtained is maintained by the switch controller 170 in the subsequent ignition, run-up, and normal operational modes.

In the embodiment of FIG. 6B, the switch controller 170 generates its offset signal Δ for the subtractor 190 in such a way that the signal S₁′ received at its sensor input 176 is equal to zero within a certain predefined range of tolerances.

The value of the offset signal Δ thus obtained is maintained by the switch controller 170 in the subsequent ignition, run-up, and normal operational modes.

During normal operation, it may happen that the offset of the current sensor changes; especially in the first minutes after lamp ignition, the temperature of the driver is expected to change and, as a result, offset changes of the current sensor are expected. It is noted that it is not possible for the driver to switch to the calibration mode as described above, because then the lamp would extinguish.

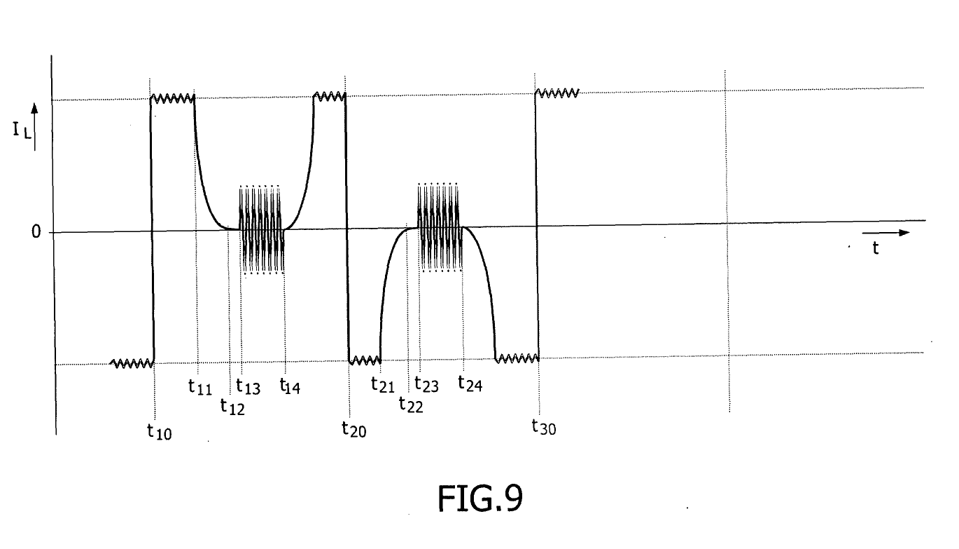

In accordance with a further aspect of the invention, the switch controller 170 is capable of operating in a recalibration mode during the normal operational mode. In this recalibration mode, the switch controller 170 alternates normal operation with calibration measurement operation, as illustrated in FIG. 9. FIG. 9 is a graph showing the load current I_{L} as a function of time, on a time scale comparable to the time scale of FIG. 3. At instant t10, when the switch controller 170 is in its normal operation, the commutator bridge 120 is switched to its LOW state (compare instant t7 in FIG. 3). The subsequent commutation instants are instants t20 and t30. The phase from instant t10 to instant t20 will be indicated as the positive current period, whereas the phase from instant t20 to instant t30 will be indicated as the negative current period; the phase from t10 to t30 will be indicated as the entire current period.

At instant t11 during the positive current period, the switch controller 170 enters a calibration measurement operation by switching the down-converter bridge 110 to its OFF state. Instant t11 is preferably chosen to be such that (t11-t10) is approximately equal to 10%-30% of (t20-t10).

The energy in the system discharges via the commutator bridge 120, which takes about 100 to 200 μsec, depending on the actual circuit design, as should be clear to a person skilled in the art. Then, no DC current can flow in the load L any more. To make sure that no current can flow in the load L, indeed, the commutator bridge 120 is switched to its OFF state at instant t12. Then, starting at t13, the down-converter bridge 110 is operated again at a high frequency, preferably the same frequency as during normal operation, producing an AC current in the first inductor 131 and the first capacitor 141, which AC current has a zero DC level.

At instant t14, the commutator bridge 120 is switched to its LOW state again, so as to end the calibration measurement operation and to resume normal operation. The duration from instant t13 to instant t14, which will be indicated as the AC current phase of the calibration measurement operation, may typically be of the order of about 100 μsec.

During the calibration measurement operation, the lamp L is off. The entire calibration measurement operation from instant t11 to instant t14 has a very short duration, typically less than 500 μsec, so that, at instant t14, the lamp L is still hot enough to re-ignite immediately. Furthermore, the normal lamp operation is interrupted so briefly that it is not disturbing to the human eye. In any case, the calibration measurement operation from instant t11 to instant t14 falls entirely within the positive current period.

During the AC current phase of the calibration measurement operation, the switch controller 170 receives the current-measuring signal S1 from the current sensor 150, and calculates the DC level of the current-measuring signal S1. This DC level during the positive current period will be indicated as DC[+].

In a similar manner, a calibration measurement operation is performed from instant t21 to instant t24 during a negative current period. Again, the DC level of the current-measuring signal S1 is calculated; this DC level during the negative current period will be indicated as DC[−]. Although it is possible that one or more “uninterrupted” current periods are passing between these two calibration measurement operations, it is preferred that this subsequent calibration measurement operation is performed in the negative current period which immediately follows the positive current period t10-t20, as illustrated.

The above-described sequence of a calibration measurement operation during a positive current period and a calibration measurement operation during a subsequent negative current period will be indicated as a calibration measurement sequence. As already mentioned, a calibration measurement sequence preferably takes place during one full current period.

Although, in principle, it may be sufficient to have only one calibration measurement sequence, it is preferred to repeat the calibration measurement sequence a few times, for instance, 10 times. The combination of these calibration measurement sequences will be indicated as a calibration measurement cycle. The calibration measurement sequences may be performed in subsequent full current periods, but it is also possible that one or more positive or negative current periods are skipped before the next calibration measurement sequence.

Each calibration measurement sequence will yield a value for DC[+] and a value for DC[−]. Thus, the calibration measurement cycle will yield a plurality of values for DC[+]; the average of these values will be indicated as <DC[+]>. Likewise, the calibration measurement cycle will yield a plurality of values for DC[−]; the average of these values will be indicated as <DC[−]>.

If the current sensor 150 operates free from any offset, said average values <DC[+]> and <DC[−]> will be equal to zero. A sensor calibration correction value SCC will be calculated as SCC=α·(<DC[+]>+<DC[−]>)/2, wherein α is a factor which may be predetermined, or determined empirically.

In the next step, the switch controller 170 will adjust the current sensor correction setting, using said sensor calibration correction value SCC.

For instance, in the embodiment of FIG. 1, the switch controller 170 will adjust the reference control signal SC_{R} for the current reference signal generator 160 in accordance with

SC_{R}(NEW)=SC_{R}(OLD)+SCC.

In the embodiment of FIG. 6A, the switch controller 170 will adjust the offset signal Δ_{C} for the adder 180 in accordance with

Δ_{C}(NEW)=Δ_{C}(OLD)+SCC.

In the embodiment of FIG. 6B, the switch controller 170 will adjust the offset signal Δ for the subtractor 190 in accordance with

Δ(NEW)=Δ(OLD)+SCC.

It should be clear that the offset of the current sensor 150 is not fully compensated if α is too small, whereas the offset of the current sensor 150 is overcompensated if α is too high. It is not necessary that α is exactly correct, as long as it is ensured that the offset after adjustment is smaller than before. Then, the offset can be reduced in subsequent steps by repeating the calibration measurement cycle a few times. The switch controller 170 may decide to quit the recalibration mode when it finds SCC to be smaller than a predetermined threshold.

The entire recalibration mode may last a relatively short time. If a calibration measurement cycle takes ten subsequent calibration measurement sequences, and if the calibration measurement cycle is performed ten times, the entire recalibration mode will take about one second, assuming that the commutation frequency is 100 Hz.

The recalibration mode is preferably performed repeatedly, wherein the intervals between subsequent recalibration modes may be relatively short (about 10 seconds to 1 minute) shortly after ignition, while the intervals between subsequent recalibration modes may increase later. Eventually, once the lamp has been burning for a sufficiently long time, it may be decided that the recalibration mode is no longer necessary.

It is also possible that means are provided for generating a signal which is indicative of a parameter of the environment, for instance, temperature. In such a case, such a parameter may be monitored, and a recalibration mode may be performed when such a parameter has changed by a certain predefined amount or a certain predefined percentage.

It should be clear to a person skilled in the art that the invention is not limited to the embodiments described above by way of example, and that several variations and modifications are possible within the protective scope of the invention as defined in the appendent claims.

The invention has been explained hereinbefore with reference to block diagrams, which illustrate functional blocks of the device according to the invention. It is to be understood that one or more of these functional blocks may be implemented in hardware, wherein the function of such a functional block is performed by individual hardware components, but one or more of these functional blocks may alternatively be implemented in software, so that the function of such a functional block is performed by one or more program lines of a computer program or a programmable device such as a microprocessor, a microcontroller, a digital signal processor, etc.

1. A method of calibrating a CDCCD circuit (100) for operating a load (L), the CDCCD circuit (100) comprising:
a first input terminal (101) and a second input terminal (102) connected to an input voltage source;
a first switching bridge (110) comprising a first controllable switch (111) and a second controllable switch (112) connected in series between said first and second input terminals (101, 102);
a second switching bridge (120) comprising a third controllable switch (121) and a fourth controllable switch (122) connected in series between said first and second input terminals (101, 102);
a first inductor (131) coupled between a first load output terminal (191) and a first bridge output node (113) between said first and second controllable switches (111, 112) of said first switching bridge (110);
a second inductor (132) coupled between a second load output terminal (192) and a second bridge output node (123) between said third and fourth controllable switches (121, 122) of said second switching bridge (120);
a first capacitor (141) coupled between said first load output terminal (191) and one of said first and second input terminals (101, 102);
a second capacitor (142) coupled between said second load output terminal (192) and one of said first and second input terminals (101, 102);
a current sensor (150) associated with said first inductor (131), designed to generate a first measuring signal (S1) representing the current in said first inductor (131);
a current reference signal generator (160), designed to generate a current reference signal (SR);
a switch controller (170) having a sensor input (176) coupled to the current sensor (150) for receiving the first measuring signal (S1), a reference input (177) coupled to the current reference signal generator (160) for receiving the current reference signal (SR), and first, second, third and fourth control outputs (171, 172, 173, 174) coupled to control inputs of the first, second, third, and fourth controllable switches (111, 112, 121, 122), respectively;
the switch controller (170) having a normal operational mode in which the switch controller (170) is designed to generate first and second mutually opposite control signals (SC1, SC2) at its first and second control outputs (171, 172) for switching the first and second controllable switches (111, 112) of said first switching bridge (110) at a first frequency, and to generate third and fourth mutually opposite control signals (SC3, SC4) at its third and fourth control outputs (173, 174) for switching the third and fourth controllable switches (121, 122) of said second switching bridge (120) at a second frequency differing from the first frequency, such that the first measuring signal (S1) received at its sensor input (176) corresponds to the current reference signal (SR) received at its reference input (177);
the method comprising the steps of:
generating in said first inductor (131) an AC current having a zero DC level;
measuring the voltage at said first output terminal (191) and providing a voltage-measurement signal (S2);
adjusting the current reference signal (SR) so that the voltage-measurement signal (S2) is symmetrical with respect to the voltage levels (V(101); V(102)) at the first and second input terminals (101; 102).

2. A method as claimed in claim 1, comprising the steps of:
measuring the absolute value (VA) of the difference between a top level (VT) of the voltage-measurement signal (S2) and the voltage level V(101) at the first input terminal (101);
measuring the absolute value (VB) of the difference between a minimum level (VL) of the voltage-measurement signal (S2) and the voltage level V(102) at the second input terminal (102);
calculating the difference (VA−VB) between said absolute values;
adjusting the current reference signal (SR) so that the absolute value of said difference (VA−VB) is reduced.

3. A method as claimed in claim 2, wherein the step of adjusting the current reference signal (SR) is repeated until the absolute value of said difference (VA−VB) is smaller than a predetermined threshold.

4. A method as claimed in claim 1, wherein the voltage at said first output terminal (191) is measured while the second switching bridge (120) is maintained in an OFF state.

5. A method as claimed in claim 4, wherein the first switching bridge (110) is switched between its HIGH state and its LOW state and back at a frequency substantially corresponding to said first frequency.

6. A method as claimed in claim 1, comprising the step of adjusting the setting of the current reference signal generator (160).

7. A method as claimed in claim 1, comprising the step of adding a compensation value (ΔC) to the current reference signal (SR) generated by the current reference signal generator (160).

8. A method as claimed in claim 1, comprising the step of subtracting a compensation value (Δ) from the sensor output signal (S1).

9. A method of operating a CDCCD circuit (100) for operating a load (L), the CDCCD circuit (100) comprising:
a first input terminal (101) and a second input terminal (102) connected to an input voltage source;
a first switching bridge (110) comprising a first controllable switch (111) and a second controllable switch (112) connected in series between said first and second input terminals (101, 102);
a second switching bridge (120) comprising a third controllable switch (121) and a fourth controllable switch (122) connected in series between said first and second input terminals (101, 102);
a first inductor (131) coupled between a first load output terminal (191) and a first bridge output node (113) between said first and second controllable switches (111, 112) of said first switching bridge (110);
a second inductor (132) coupled between a second load output terminal (192) and a second bridge output node (123) between said third and fourth controllable switches (121, 122) of said second switching bridge (120);
a first capacitor (141) coupled between said first load output terminal (191) and one of said first and second input terminals (101, 102);
a second capacitor (142) coupled between said second load output terminal (192) and one of said first and second input terminals (101, 102);
a current sensor (150) associated with said first inductor (131), designed to generate a first measuring signal (S1) representing the current in said first inductor (131);
a current reference signal generator (160), designed to generate a current reference signal (SR);
a switch controller (170) having a sensor input (176) coupled to the current sensor (150) for receiving the first measuring signal (S1), a reference input (177) coupled to the current reference signal generator (160) for receiving the current reference signal (SR), and first, second, third and fourth control outputs (171, 172, 173, 174) coupled to control inputs of the first, second, third, fourth controllable switches (111, 112, 121, 122), respectively;
the switch controller (170) having a normal operational mode in which the switch controller (170) is designed to generate first and second mutually opposite control signals (SC1, SC2) at its first and second control outputs (171, 172) for switching the first and second controllable switches (111, 112) of said first switching bridge (110) at a first frequency, and to generate third and fourth mutually opposite control signals (SC3, SC4) at its third and fourth control outputs (173, 174) for switching the third and fourth controllable switches (121, 122) of said second switching bridge (120) at a second frequency differing from the first frequency, such that the first measuring signal (S1) received at its sensor input (176) corresponds to the current reference signal (SR) received at its reference input (177);
the method comprising the step of:
operating the switch controller (170) in its normal operational mode with the current reference signal (SR) adjusted as determined by means of the calibration method as claimed in claim 1.

10. A method of recalibrating a CDCCD circuit (100) for operating a load (L), the CDCCD circuit (100) comprising:
a first input terminal (101) and a second input terminal (102) connected to an input voltage source;
a first switching bridge (110) comprising a first controllable switch (111) and a second controllable switch (112) connected in series between said first and second input terminals (101, 102);
a second switching bridge (120) comprising a third controllable switch (121) and a fourth controllable switch (122) connected in series between said first and second input terminals (101, 102);
a first inductor (131) coupled between a first load output terminal (191) and a first bridge output node (113) between said first and second controllable switches (111, 112) of said first switching bridge (110);
a second inductor (132) coupled between a second load output terminal (192) and a second bridge output node (123) between said third and fourth controllable switches (121, 122) of said second switching bridge (120);
a first capacitor (141) coupled between said first load output terminal (191) and one of said first and second input terminals (101, 102);
a second capacitor (142) coupled between said second load output terminal (192) and one of said first and second input terminals (101, 102);
a current sensor (150) associated with said first inductor (131), designed to generate a first measuring signal (S1) representing the current in said first inductor (131);
a current reference signal generator (160), designed to generate a current reference signal (SR);
a switch controller (170) having a sensor input (176) coupled to the current sensor (150) for receiving the first measuring signal (S1), a reference input (177) coupled to the current reference signal generator (160) for receiving the current reference signal (SR), and first, second, third and fourth control outputs (171, 172, 173, 174) coupled to control inputs of the first, second, third, fourth controllable switches (111, 112, 121, 122), respectively;
the switch controller (170) having a normal operational mode in which the switch controller (170) is designed to generate first and second mutually opposite control signals (SC1, SC2) at its first and second control outputs (171, 172) for switching the first and second controllable switches (111, 112) of said first switching bridge (110) at a first frequency, and to generate third and fourth mutually opposite control signals (SC3, SC4) at its third and fourth control outputs (173, 174) for switching the third and fourth controllable switches (121, 122) of said second switching bridge (120) at a second frequency differing from the first frequency, such that the first measuring signal (S1) received at its sensor input (176) corresponds to the current reference signal (SR) received at its reference input (177);
the method comprising the steps of:
alternatively operating the switch controller (170) in its normal operation and in a calibration measurement operation, wherein it is ensured that no DC load current flows during the calibration measurement operation, and wherein the calibration measurement operation has such a brief duration that, on resuming the normal operation, the load current re-establishes itself immediately;
determining a DC offset of the current sensor (150) during the calibration measurement operation;
after the calibration measurement operation, adjusting the setting of the circuit (100) so as to compensate for the offset determined during the calibration measurement operation.

11. A method as claimed in claim 10, wherein the calibration measurement operation is executed entirely between two subsequent commutation instants.

12. A method as claimed in claim 10, wherein the calibration measurement operation takes less than 500 μsec.

13. A method as claimed in claim 10, wherein the calibration measurement operation includes the steps of:
switching the first switching bridge (110) to its OFF state;
allowing energy to discharge from the system;
switching the second switching bridge (120) to its OFF state;
in an AC current phase, operating the first switching bridge (110) at a relatively high frequency.

14. A method as claimed in claim 13, wherein the step of resuming the normal operation includes the step of switching the second switching bridge (120) back to its HIGH state or LOW state, respectively.

15. A method as claimed in claim 13, wherein said relatively high frequency is substantially equal to the first frequency.

16. A method as claimed in claim 13, further comprising the step of determining, during said AC current phase, a DC level of the first measuring signal (S1) from the current sensor (150).

17. A method as claimed in claim 16, wherein the calibration measurement operation is executed during a positive current period, and a DC level of the first measuring signal (S1) from the current sensor (150) is determined as DC[+];
the calibration measurement operation is executed during a negative current period, and a DC level of the first measuring signal (S1) from the current sensor (150) is determined as DC[−]; and
the setting of the circuit (100) is adjusted on the basis of the average (DC[+]+DC[−])/2 of said two DC-levels.

18. A method as claimed in claim 17, wherein said positive current period and said negative current period are subsequent to each other.

19. A method as claimed in claim 17, wherein the calibration measurement operation is executed during a plurality of positive current periods, wherein a value for the DC level of the first measuring signal (S1) from the current sensor (150) is determined during each calibration measurement operation, and the average level <DC[+]> of these values is calculated;
the calibration measurement operation is executed during a plurality of negative current periods, wherein a value for the DC level of the first measuring signal (S1) from the current sensor (150) is determined during each calibration measurement operation, and the average level <DC[−]> of these values is calculated; and
the setting of the circuit (100) is adjusted on the basis of the average (<DC[+]>+<DC[−]>)/2 of said two average DC levels.

20. A method as claimed in claim 10, wherein the recalibration procedure is performed repeatedly.

21. A method as claimed in claim 20, wherein the intervals between subsequent recalibration procedures have an increasing duration.

22. A method as claimed in claim 20, wherein the intervals between subsequent recalibration procedures are based on changes in at least one parameter of the environment, such as, for instance, temperature.

23. A CDCCD circuit (100) for operating a load (L), comprising:
a first input terminal (101) and a second input terminal (102) for connection to an input voltage source;
a first switching bridge (110) comprising a first controllable switch (111) and a second controllable switch (112) connected in series between said first and second input terminals (101, 102);
a second switching bridge (120) comprising a third controllable switch (121) and a fourth controllable switch (122) connected in series between said first and second input terminals (101, 102);
a first inductor (131) coupled between a first load output terminal (191) and a first bridge output node (113) between said first and second controllable switches (111, 112) of said first switching bridge (110);
a second inductor (132) coupled between a second load output terminal (192) and a second bridge output node (123) between said third and fourth controllable switches (121, 122) of said second switching bridge (120);
a first capacitor (141) coupled between said first load output terminal (191) and one of said first and second input terminals (101, 102);
a second capacitor (142) coupled between said second load output terminal (192) and one of said first and second input terminals (101, 102);
a current sensor (150) associated with said first inductor (131), designed to generate a first measuring signal (S1) representing the current in said first inductor (131);
a current reference signal generator (160), designed to generate a current reference signal (SR);
a switch controller (170) having a sensor input (176) coupled to the current sensor (150) for receiving the first measuring signal (S1), a reference input (177) coupled to the current reference signal generator (160) for receiving the current reference signal (SR), and first, second, third and fourth control outputs (171, 172, 173, 174) coupled to control inputs of the first, second, third, fourth controllable switches (111, 112, 121, 122), respectively;
the switch controller (170) having a normal operational mode in which the switch controller (170) is designed to generate first and second mutually opposite control signals (SC1, SC2) at its first and second control outputs (171, 172) for switching the first and second controllable switches (111, 112) of said first switching bridge (110) at a first frequency, and to generate third and fourth mutually opposite control signals (SC3, SC4) at its third and fourth control outputs (173, 174) for switching the third and fourth controllable switches (121, 122) of said second switching bridge (120) at a second frequency differing from the first frequency, such that the first measuring signal (S1) received at its sensor input (176) corresponds to the current reference signal (SR) received at its reference input (177);
the switch controller (170) being designed to perform the method as claimed in claim 1.

24. A circuit as claimed in claim 23, further comprising a voltage sensor (155) having a sense input (156) connected to the first output terminal (191), and a signal output (157);
wherein the switch controller (170) has a signal input (158) coupled to the signal output (157) of the voltage sensor (155).

25. A circuit as claimed in claim 23, wherein the current reference signal generator (160) is a controllable signal generator having a control input (161);
the switch controller (170) has a fifth control output (175) coupled to the control input (161) of the reference signal generator (160);
the switch controller (170) is designed to generate at its fifth output (175) a reference control signal (SC_{R}) for the signal generator (160); and
the signal generator (160) is adapted to generate its reference signal (S_{R}) with an offset (Δ_{C}) as determined by the reference control signal (SC_{R}) as received at its control input (161).

26. A circuit as claimed in claim 23, wherein the switch controller (170) has an offset output (178) providing an offset signal (Δ_{C});
the switch controller (170) is provided with an adder (180) having a first input (186) coupled for receiving the current reference signal (S_{R}) from the signal generator (160), a second input (188) coupled to the offset output (178) of the switch controller (170), and an output (187) coupled to the reference input (177) of the switch controller (170).

27. A circuit as claimed in claim 26, wherein the adder (180) is an integral part of the switch controller (170).

28. A circuit as claimed in claim 23, wherein the switch controller (170) has an offset output (179) providing an offset signal (Δ);
the switch controller (170) is provided with a subtractor (190) having a first input (198) coupled for receiving a sensor output signal (S₁), a second input (199) coupled to the offset output (179) of the switch controller (170), and an output (196) coupled to the sensor input (176) of the switch controller (170).

29. A circuit as claimed in claim 28, wherein the subtractor (190) is an integral part of the switch controller (170).
